(19) United States
(12) Patent Application Publication
(10) Pub. No.: US 2022/0087297 A1
(43) Pub. Date: Mar. 24, 2022

(54) Fruit and Whey Compositions

(71) Applicant: Sodima, Boulogne-Billancourt (FR)

(72) Inventor: Elodie Bellet Mosnier, Lyon (FR)

(73) Assignee: Sodima, Boulogne-Billancourt (FR)

(21) Appl. No.: 17/433,664

(22) PCT Filed: Mar. 15, 2019
(86) PCT No.: PCT/IB2019/000301

§ 371 Date: Aug. 25, 2021

(51) Int. Cl. A23L 33/19; A23L 19/00; A23L 21/12; A23C 9/13; A23C 9/133

(52) U.S. Cl. CPC A23L 33/19; A23L 19/09; A23V 2002/00; A23C 9/1307; A23C 9/133; A23L 21/12

(57) ABSTRACT

Fruit preparations comprising whey and having a desirable viscosity and texture are described. Fruit preparations described include about 3% to 16% whey protein by weight and at least 30% fruit ingredient by weight. Methods of making fruit preparations comprising whey are also described.

### BACKGROUND

Fruit preparations, such as sauces, jams, marmalades, and jellies, are a way to add interest and flavor to foods, such as yogurt, ice cream, bread, cottage cheese, or drinks. A fruit preparation is generally made by cooking whole fruit, pieces, puree, and/or juice, with water and sugar, and other ingredients, such as stabilizers, colorants, and/or flavorants, to produce the fruit preparation.

Consumers are increasingly looking for food that contain fewer and simpler ingredients. It can be difficult, however, to meet the consumer desire for simpler foods while maintaining other aspects of the eating experience that consumers expect, such as texture, flavor, and appearance. In addition, foods made with fewer or simpler ingredients should also retain attributes that make them amenable to manufacture, such as pumpability, storage life, shelf life, and compatibility with other ingredients, such as yogurt.

### SUMMARY

The present disclosure relates to a fruit preparation that includes a whey protein matrix.

Provided herein is a fruit preparation. A fruit preparation can have a pH of from 3 to 4.5, a dynamic viscosity of 0.5 to 4 Pa*s as measured at 10° C. and 60 s-1, and a consistency of from about 5 cm/min to about 8 cm/min as measured at 10° C., where the fruit preparation consists of about 3% to about 10% by weight whey protein, at least 30% by weight fruit ingredient, up to 20% water, up to 59% by weight sugar, and up to 10% additives.

In some embodiments, a fruit ingredient can include fruit pieces.

In some embodiments, a fruit preparation can include up to 5% by weight organic acid.

In some embodiments, a fruit preparation can form a semi-transparent or transparent gel.

In some embodiments, a fruit preparation can include whey protein in an amount of about 5% to about 7% by weight.

A food product is also provided, the food product including a fruit preparation described herein, and a second edible composition. In some embodiments, a second edible composition can be a dairy product.

A method of making a fruit preparation is also provided. In some embodiments, a method of making a fruit preparation can include combining a whey protein solution with a fruit ingredient to produce a mixture having about 4% to about 10% by weight whey protein, at least 30% fruit ingredient, up to 20% water, up to 59% by weight sugar, and up to 10% additives; pasteurizing the mixture at a temperature of from 85° C. to 100° C. for 2 minutes to 15 minutes; and cooling the mixture to a temperature of 40° C. or less to produce the fruit preparation, the fruit preparation having a pH of from 3 to 4.5, a dynamic viscosity of 0.5 to 4.0 Pa*s as measured at 10° C. and 60 s-1, and a consistency of from about 5 cm/min and about 8 cm/min as measured at 10° C.

In some embodiments, a method of making a fruit preparation can include combining a whey protein powder with a fruit juice or fruit puree to produce a mixture having about 4% to about 10% by weight whey protein, at least 30% by weight fruit, up to 20% water, up to 59% by weight sugar, and up to 10% additives; pasteurizing the mixture at a temperature of from 85° C. to 100° C. for 2 minutes to 15 minutes; and cooling the mixture to a temperature of 40° C. or less to produce the fruit preparation, the fruit preparation having a pH of from 3 to 4.5, a dynamic viscosity of 0.5 to 4.0 Pa*s as measured at 10° C. and 60 s-1, and a consistency of from about 5 cm/min and about 8 cm/min as measured at 10° C.

In some embodiments, a method of making a fruit preparation can include a step of acidifying the mixture or adding calcium. In some embodiments, a step of acidifying can be performed by adding an organic acid or a fruit or vegetable juice.

In some embodiments, a method of making a fruit preparation can include thermally treating a whey protein solution to achieve at least 60% denaturation to form a whey base, the whey protein solution having a protein concentration of about 6% to about 40% by weight; pasteurizing the whey base; and combining the whey base with a fruit ingredient to produce the fruit preparation, the fruit preparation having about 3% to about 10% by weight whey protein, at least 30% by weight fruit, up to 20% water, up to 59% by weight sugar, and up to 10% additives, and having a pH of from 3 to 4.5 and a dynamic viscosity of 0.5 to 4 Pa*s as measured at 10° C. and 60 s-1, and a consistency of from about 5 cm/min to about 8 cm/min as measured at 10° C.

In some embodiments of a method of making a fruit preparation, a thermal treatment of the whey protein solution can be at a temperature of from 60° C. to 80° C. for 5 to 50 minutes at a pH greater than 4.5.

In some embodiments of a method of making a fruit preparation, a thermal treatment step and a pasteurization step can be performed at substantially the same time.

In some embodiments of a method of making a fruit preparation, a whey base can be pasteurized after combining with the fruit ingredient.

In some embodiments of a method of making a fruit preparation, a whey protein solution can be thermally treated at a pH of greater than 6.

In some embodiments of a method of making a fruit preparation, a fruit ingredient can have a pH of less than 4.

In some embodiments of a method of making a fruit preparation, the method can further include a step of acidifying the fruit preparation. In some embodiments, a step of acidifying can be performed by adding an organic acid or a fruit or vegetable juice.

In some embodiments of a method of making a fruit preparation, a whey protein solution can have a whey protein concentration of about 6% to about 40%.

In some embodiments of a method of making a fruit preparation, a whey protein solution can have a whey protein concentration of about 12% to about 30%.

In some embodiments of a method of making a fruit preparation, the fruit preparation can include whey in an amount of about 5% to about 7% by weight.

In some embodiments of a method of making a fruit preparation, a whey protein solution can contain up to 50% sugar by weight.

In some embodiments of a method of making a fruit preparation, the fruit preparation can have a Ca2+ concentration of from about 20 mM to about 50 mM.

In some embodiments of a method of making a fruit preparation, the method can further include a step of adding Ca2+ to achieve a fruit preparation having a Ca2+ concentration of from about 20 mM to about 50 mM.

These and various other features and advantages will be apparent from a reading of the following detailed description.

### DRAWINGS

FIG. 1 shows an example of a fruit preparation described herein. The fruit preparation was made using a hot gelation method (see, Example 1), with a whey protein solution at pH 3.5. The fruit preparation is red-pink in color, with a viscous matrix, with visible fruit pieces of various sizes, and is stable over time.

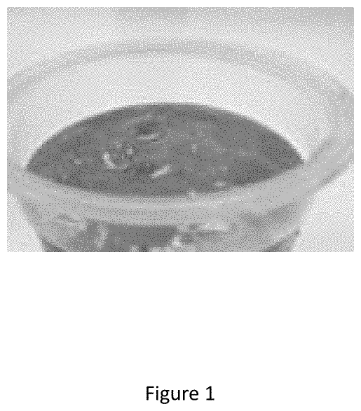

FIG. 2 shows an example of a fruit preparation described herein. The fruit preparation was made using a hot gelation method (see, Example 1), with a whey protein solution at pH 6.5. The fruit preparation is pink in color with a whitish appearance, and has a viscous matrix, with visible fruit pieces of various sizes, and is stable over time.

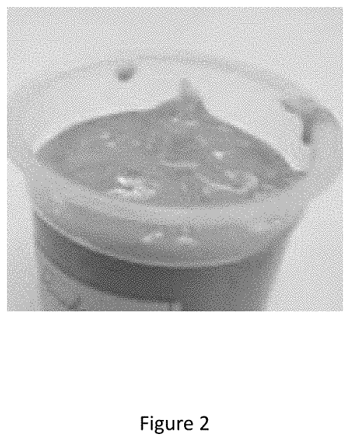

FIG. 3 shows an example of a fruit preparation described herein. The fruit preparation was made using a hot gelation method (see, Example 1), with a whey protein solution at pH 3.5. The fruit preparation is red in color, has a smooth, fluid texture, with well-preserved pieces that sink to the bottom over time.

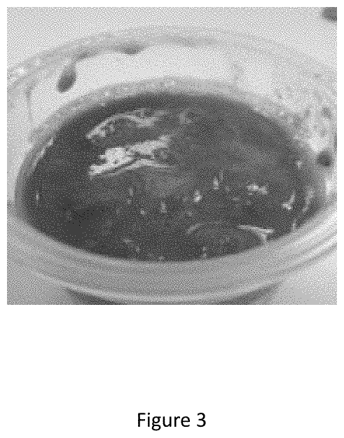

FIG. 4 shows an example of a fruit preparation described herein. The fruit preparation was made using a cold gelation method (see, Example 2), with a whey protein solution denatured at pH 7. The fruit preparation is violet in color, with very thick texture. The fruit preparation also has a sandy texture with visible protein grains (although the protein grains are not perceived when the fruit preparation was combined with a yogurt white mass), and acceptable fruit pieces, but is prone to slight syneresis over time.

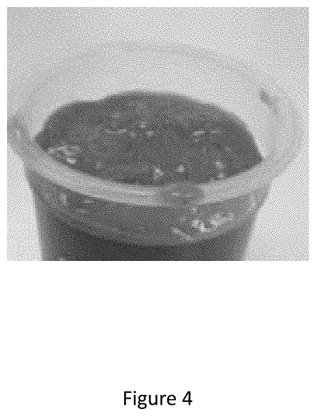

### DETAILED DESCRIPTION

Fruit preparations are challenging to simplify since commonly used ingredients, such as stabilizers (e.g., pectin, alginate, carrageenan, starch, xanthan gum, guar gum, and the like), flavorants, and colorants, can contribute to the expected eating experience as well as manufacturability attributes. Even more challenging is the inclusion of fruit pieces in a preparation because the viscosity must be sufficient to maintain the fruit pieces in suspension.

It was discovered, and is disclosed herein, that a fruit preparation that includes fruit pieces having a desirable texture, flavor, and appearance can be produced with a few simple ingredients, including a fruit ingredient and whey protein. A fruit preparation provided herein includes fruit pieces and has a dynamic viscosity and consistency similar to a traditional fruit preparation.

A fruit preparation has a dynamic viscosity of from about 0.85 to about 4 Pa*s (e.g., from about 1 to about 3 Pa*s, or about 1.2 to about 2.5 Pa*s). Dynamic viscosity, as provided herein is measured at 10° C. and 60 s-1 using a Rheolix™ rheometer (VIONEC Technologies, Inc., Terrebonne, Quebec, Canada).

A fruit preparation provided herein has a consistency of from about 4 cm/min to about 8 cm/min (e.g., from about 6 to about 7 cm/min). Consistency, as provided, herein, is measured at 10° C. using a Bostwick consistometer (also referred to as “Bostwick Cenco” herein; CSC Scientific Company, Inc., Fairfax, Va., USA).

A fruit preparation provided herein contains a fruit ingredient in an amount of at least 30% fruit (e.g., from about 50% to about 75%, from about 55% to about 70%, or from about 60% to about 70%) by weight of the fruit preparation. As used herein, a fruit ingredient is an edible ingredient derived from a fruit or vegetable, such as fruit pieces, fruit juice, and/or fruit puree. In some embodiments, a fruit juice or a fruit puree can be defined according to the Food and Agriculture Organization of the United Nations Codex General Standard for Fruit Juices and Nectars (Codex Standard 247-2005). A fruit ingredient can be derived from any edible fruit or vegetable, such as berries (e.g., strawberry, raspberry, blueberry, banana, tomato, peppers, and the like), stone fruit (e.g., cherry, apricot, plum, peach, and the like), nuts (e.g., coconut, almond, cashew, and the like), legumes (e.g., peanut, soy, pea, and the like), vegetables (e.g., carrot, rhubarb, spinach, and the like), or combinations thereof. Fruit ingredients are available commercially or can be made from an edible fruit or vegetable using any appropriate method. A fruit ingredient provided herein can be fresh or frozen, or can be preserved using, for example, cooking or pressurized carbon dioxide preservation (see, for example WO 2018/005081).

At least a portion of a fruit ingredient in a fruit preparation provided herein includes fruit pieces. Fruit pieces can be included in a fruit preparation in an amount of at least 15% (e.g., from about 30% to about 75%, from about 55% to about 70%, or from about 60% to about 70%) by weight of the fruit preparation. In some embodiments, fruit pieces can be at least 5 mm (e.g., 5 mm to 1.5 cm) in at least one dimension.

A fruit preparation provided herein contains whey protein in an amount of from 1.5% to about 16% (e.g., from about 3% to about 10%, from about 4% to about 8%, from about 4% to about 6%, or about 5%) by weight of the fruit preparation.

A whey protein can be added to a fruit preparation provided herein as a whey protein powder or as a whey protein solution (i.e., a whey protein powder dispersed or dissolved in an aqueous solvent). A whey protein powder can be a whey protein concentrate (i.e., 70% to less than 90% whey protein by weight) or a whey protein isolate (i.e., 90% or more whey protein by weight). Whey protein can be from any appropriate source, including whey sourced from milk or as a by-product (e.g., from cheese or yogurt production).

A whey protein solution suitable for use in a fruit preparation provided herein can include from about 15% to about 40% (e.g., from about 25% to about 35%, or about 30%) by weight whey protein. In some embodiments, a whey protein solution can also include all or part of the sugar and/or acidulent included in a fruit preparation provided herein.

A whey protein solution can be produced using any appropriate method and equipment. For example, a whey protein solution can be made by combining a whey protein powder, water, and optionally sugar and/or acidulent, in a mixer. Suitable mixing equipment and methods should ensure that the whey is sufficiently dispersed, wetted, and hydrated in order to form a solution. Since whey protein hydration time is a function of temperature, a shorter mixing time can be used at higher temperatures. In addition, salts or minerals present in tap water can increase whey protein solubility as compared to using distilled water. Using higher temperatures (e.g., 40-60° C.) and/or using tap water can also improve repeatability of whey protein solubility. For example, a whey protein solution can be made by combining whey protein powder to water heated to about 40° C. to less than 60° C. (e.g., about 50° C.) to achieve the desired protein concentration, then dispersed under high shear (e.g., mixed in a Silverson laboratory mixer (Silverson Machines, Inc., Massachusetts, USA) for 10 minutes at 5000 rpm) to disperse and wet the whey protein. The whey protein can then be further hydrated and dissolved at low shear (e.g., by low speed agitation for 30 minutes). Optionally, sugar and/or a pH adjusting component (e.g., an acidulent) can be dissolved in the water prior to adding the whey protein, for example, by mixing in a Silverson laboratory mixer for 2 minutes at 3000 rpm.

Due to undesired whey protein functionality and lower solubility near the isoelectric point of the whey protein (about pH 5.2), preferably, the solution is maintained at a pH either above or below the isoelectric point of the whey protein. That is, it is preferred that a whey protein solution be made at a pH of less than 5 (e.g., 3 to 4.5) or above 5.5 (e.g., 6 to 8). It has been observed that whey protein has a slightly better solubility above pH 5.5 than at or below pH 4. However, at a pH at or below 4, the gel tends to be more transparent and yellowish, strong, brittle, elastic, with low or no syneresis. In contrast, at a pH at or above 6, the gel is whiter and more opaque, strong and brittle, but with more syneresis. In some embodiments, a whey protein solution can be stored at refrigeration temperature (e.g., about 4° C.) prior to use in a fruit preparation provided herein.

Whey protein, either in a whey protein solution or in combination with a fruit ingredient, is thermally treated. In both cases, the thermal treatment is sufficient to achieve at least 50% (e.g., at least 60%, at least 70%, or at least 80%) denaturation of the whey protein in the solution to form a whey base. As used herein, denaturation of whey protein is measured by Bradford spectroscopic analysis. If a whey protein is thermally treated in a whey protein solution, the thermal treatment can be sufficient to pasteurize the solution. A whey base can be combined with a pasteurized fruit ingredient to produce a fruit preparation.

If a whey protein is thermally treated in combination with a fruit ingredient, the thermal treatment can be sufficient to pasteurize the combination. For example, a combination of whey protein and fruit ingredient can be thermally treated at a temperature of from about 85° C. to about 100° C. for 2 minutes to 15 minutes.

Whey protein in a fruit preparation provided herein can have a solubility index percentage (Iₛ) of at least 95% (e.g. at least 98%, or at least 99%). To calculate solubility index, a whey protein solution is prepared by combining whey protein powder with water at a temperature of 40° C. to less than 60° C. (e.g., about 50° C.), and mixing using a Silverson laboratory mixer at 5000 rpm for 10 minutes to disperse and wet the whey protein. The mixture is then mixed at low shear using a magnetic agitator for 30 minutes without further application of heat to hydrate and dissolve the whey protein to make the whey protein solution. 50 ml of the solution is centrifuged a first time at a centrifugal force of about 174 g (e.g., about 1200-1300 rpm in an Eppendorf Centrifuge 5810R, with rotor F-34-6-38) for 5 minutes in a 50 ml Falcon® tube (Corning Life Sciences, Corning, N.Y., USA). Following the first centrifugation, the liquid above the 5 ml mark on the Falcon® tube is removed from any sediment at the bottom. The sediment is combined with a fresh amount of distilled water to a volume of 50 ml in the Falcon tube and dispersed until a second solution is formed. The second solution is centrifuged a second time at a centrifugal force of about 174 g for 5 minutes. The volume of sediment from the second centrifugation is measured. The insolubility index (Iₜ) of the whey protein is the volume of the sediment from the second centrifugation in milliliters. As used herein Iₛ of a whey protein is calculated from the insolubility index (Iₜ) of the whey protein solution, using the formula: Iₛ=100−(2×Iₜ).

A fruit preparation provided herein can optionally include sugar in an amount of up to 59% (e.g., from about 10% to about 20%, from about 12% to about 18%, or about 15%) by weight of the fruit preparation. Sugars suitable for use in a fruit preparation provided herein include sucrose, fructose, honey, glucose syrup, maple syrup, and the like, and combinations thereof. As used herein, the term “sugar” refers to a caloric sweetener. However, non-caloric sweeteners can also be used in addition to, or as a replacement for, sugar to modify the sweetness of a fruit preparation. In some embodiments, sugar can increase gel firmness of a whey protein gel. Without being bound to theory, it is believed that sugar can have a bulking effect on a whey protein solution used to form a gel.

A fruit preparation provided herein can optionally contain added water in an amount of up to 68% (e.g., from about 5% to about 50%, or from about 10% to about 30%, or up to about 20%) by weight of the fruit preparation. In some embodiments, water can be included as part of a whey protein solution. The amount of water included in a fruit preparation can be adjusted as appropriate based on the other ingredients included in the fruit preparation. For example, if the fruit ingredient used is a fruit juice, little or no additional water may be included in the fruit preparation since fruit juice has a relatively high moisture content. It is to be understood that the amount of water included in a fruit preparation provided herein does not include the moisture content of included fruit ingredient(s).

In some embodiments, a fruit preparation can include up to 10% (e.g., up to 8%, or up to 5%) by weight additives. Additives suitable for use in a fruit preparation provided herein include pH adjusters (e.g., compositions that increase pH, such as baking soda, and the like; and compositions that decrease pH, such as calcium salts, organic acids, such as lactic acid, malic acid, tartaric acid, or citric acid, fruit or vegetable juices, such as lemon juice or orange juice, and the like), flavorants (e.g., fruit juices, flavor extracts, essential oils, and the like), colorants (e.g., titanium dioxide, plant juices or extracts, or the like), salts (e.g., sodium salts, calcium salts, and the like), fibers (e.g., oat fiber, apple fiber, inulin, and the like), antioxidants (e.g., ascorbic acid), preservatives (e.g., sorbic acid), and stabilizers (e.g., starch, pectin, carrageenan, xanthan gum, carob bean gum, guar gum, and the like).

A fruit preparation provided herein has a pH of from about 3 to about 4.5 (e.g., from about 3.5 to about 4.2). In some embodiments, fruit preparation pH can be adjusted by adding an acidulent, such as a calcium salt, an organic acid (e.g., lactic acid, malic acid, tartaric acid, or citric acid), a fruit or vegetable juice (e.g., lemon juice, lime juice, or orange juice), or composition that increases pH, such as baking soda, to the fruit preparation or any of the ingredients used to make the fruit preparation.

In some embodiments, a fruit preparation provided herein can have a Ca2+ concentration of from about 20 mM to about 50 mM (e.g., from about 25 mM to about 40 mM). Ca²⁺ can contribute to viscosity and/or consistency of a fruit preparation. In some embodiments, inclusion of Ca²⁺ can decrease time and/or temperature of gelation of a fruit preparation provided herein, especially if the pH is greater than 5. In some embodiments, inclusion of Ca²⁺ can increase strength and/or brittleness of a gel in a fruit preparation provided herein. In some embodiments, Ca²⁺ concentration in a fruit preparation can be adjusted by adding Ca²⁺ to the fruit preparation or any of the ingredients used to make the fruit preparation. For example, a calcium salt can be added to a fruit ingredient or whey protein solution used to make a fruit preparation. In some embodiments, Ca²⁺ can be added to a fruit preparation from a water source rather than added as a calcium salt.

Suitable calcium sources include, without limitation, calcium citrate, calcium phosphate, calcium chloride, calcium lactate, calcium lacto-gluconate, and milk calcium. Calcium chloride provides easy solubility in water, and has the ability to encourage a strong gel. Calcium phosphate or calcium citrate can provide benefits of a smooth gel with low or no syneresis, but is less soluble in water. Milk calcium has a benefit of being particularly soluble, but is more likely to crystallize at a low pH and is more prone to syneresis. Calcium lactate and lacto-gluconate also have good solubility, but are more likely to cause some whey protein precipitation. Calcium source can be more influential at a pH≥6 as compared to at a pH≤4.5 where it is more soluble. Thus, at lower pH, a wider variety of calcium may be used without significant differences in function.

A fruit preparation provided herein can be used in any composition or product that a typical fruit preparation can be used in. For example, a fruit preparation provided herein can be combined with a second edible composition, such as a dairy product (e.g., yogurt, cheese, or ice cream). In some embodiments, a fruit preparation can be blended with a second edible composition, such as in a blended yogurt product. In some embodiments, a fruit preparation can be distinct from a second edible composition, such as in a fruit on the bottom, fruit on the side, or fruit on the top yogurt product.

### EXAMPLES

### Example 1—Fruit Preparation with Heat-Gelled Whey Protein (Also Referred to Herein as “Hot Gelation”)

Samples were produced as shown in Table 1. Briefly, ingredients were combined, then thermally treated at the times and temperatures indicated in Table 1. Whey protein solutions at concentrations of 16-33% by weight were made by combining a whey protein concentrate powder (80% protein) with water, then eventually adjusting the pH to less than 4.5 using citric acid. Two different whey protein sources were tested. Samples (0), 1-8, and 11 included one whey protein source, while samples 9-10 included a different whey protein source. Fruit pieces, sucrose, added water, and calcium (added as a calcium salt) were combined, mixed thoroughly, and heated to 40° C. Whey protein solution was then added to the mixture, then heat treated as indicated in Table 1 to produce fruit preparations. The resulting fruit preparations contained 65% fruit pieces by weight and 15% sucrose by weight, and other ingredients as indicated in Table 1. Following heat treatment, the fruit preparations were cooled to 20° C. and packed into containers for storage at 4° C. A control fruit preparation was made using the same ingredients and process, but without whey protein, and was used for comparison.

TABLE 1

| | | Concentration | | | | |
|---|---|---|---|---|---|---|
| | | of whey | Total | | Added | |
| | Concentration | protein | concentration | Added | water in | |
| | of whey protein | solution at | of whey | calcium | fruit | Heat |
| | solution at pH ≤ | pH ≥ 6 in fruit | protein in | (mmoles) | prep (% | treatment |
| | 4.5 in fruit prep | prep (% by | fruit prep (% | in 100 g | by | applied to |
| Sample | (% by weight) | weight) | by weight) | prep | weight) | fruit prep |
| 1 | 10% | | 1.6% | 0 | 10% | 85° C. for |
| | | | | | | 8 minutes |
| 2 | 12% | | 4% | 0 | 8% | 85° C. for |
| | | | | | | 8 minutes |
| 3 | 10% | | 1.6% | 40.32 | <10% | 85° C. for |
| | | | | | | 8 minutes |
| 4 | 12% | | 4% | 40.8 | <8% | 85° C. for |
| | | | | | | 8 minutes |
| (0) | 12% | | 3.3% | 0.33 | <8% | 85° C. for |
| | | | | | | 8 minutes |
| 5 | 10% | | 1.6% | 0 | 10% | 92° C. for |
| | | | | | | 3 minutes |
| 6 | 12% | | 4% | 0 | 8% | 92° C. for |
| | | | | | | 3 minutes |
| 7 | 10% | | 1.6% | 40.32 | <10% | 92° C. for |
| | | | | | | 3 minutes |
| 8 | 12% | | 4% | 40.8 | <8% | 92° C. for |
| | | | | | | 3 minutes |
| 9 | 18% | | 5.4% | 0 | 2% | 92° C. for |
| | | | | | | 3 minutes |
| 10 | | 18% | 5.4% | 0 | 2% | 92° C. for |
| | | | | | | 3 minutes |
| 11 | 18% | | 5.4% | 0 | 2% | 92° C. for |
| | | | | | | 3 minutes |

Dynamic viscosity was measured for each sample in Table 1 as described above, and is shown for each sample in Table 2. Observations on viscosity, mouth feel, and flavor for each sample alone, or in a yogurt white mass, are also described in Table 2.

TABLE 2

| | Dynamic viscosity | | |
|---|---|---|---|
| | of the fruit | | |
| | preparation (Pa*s | | Observations of fruit prep |
| | at 10° C. and 60 s⁻¹) | Bostwick Cenco | (Prep) and finished product |
| | at 2 days post- | (cm/min at 10° C.) at 1 | (FP) with 80% yogurt white |
| Sample | production | day post-production | mass and 20% fruit prep |
| 1 | 0.81 | | Prep: No syneresis; fruit pieces |
| | | | did not float to the top |
| | | | FP: Not very thick; very sour |
| | | | flavor, astringent, less fruity |
| | | | than sample (0) |
| 2 | 0.88 | | Prep: Syneresis and fruit |
| | | | pieces settled to the bottom; |
| | | | significant viscosity increase |
| | | | relative to control |
| | | | FP: Very thick, creamy; very |
| | | | sour flavor, astringent, and |
| | | | extremely rough in texture |
| | | | (protein aggregation) |
| 3 | 0.74 | | Prep: Syneresis; fruit pieces |
| | | | floated to the top |
| | | | FP: Liquid, smooth; bitter |
| | | | flavor |
| 4 | 0.91 | | Prep: Syneresis; fruit pieces |
| | | | floated to the top; much more |
| | | | viscous than control |
| | | | FP: Liquid, but some body in |
| | | | the mouth, smooth; very sour, |
| | | | calcium taste, but not |
| | | | astringent |
| (0) | 0.85 | | Prep: Slight syneresis; some |
| | | | flotation of fruit pieces; much |
| | | | more viscous than control |
| | | | FP: Shiny; thickest sample, |
| | | | good texture; very bitter, |
| | | | extremely sour, astringent |
| 5 | 0.79 | | Prep: Syneresis and some |
| | | | sedimentation |
| | | | FP: Very thick, creamy; very |
| | | | astringent, but good flavor |
| 6 | 1.1 | | Prep: High syneresis and |
| | | | sedimentation; much more |
| | | | viscous than control |
| | | | FP: Very thick, extremely |
| | | | rough (protein aggregation); |
| | | | extremely bitter, extremely |
| | | | astringent |
| 7 | 0.83 | | Prep: Slight syneresis; some |
| | | | flotation of fruit pieces |
| | | | FP: Somewhat thick, smooth, |
| | | | creamy; whitest appearance |
| 8 | 1.41 | | Prep: Slight syneresis and |
| | | | sedimentation; much more |
| | | | viscous than control |
| | | | FP: Very thick; brittle gel |
| | | | pieces, protein aggregation; |
| | | | unacceptable flavor |
| 9 | 2.1 | 7 | Prep: red-pink color, viscous |
| | | | matrix, visible fruit pieces of |
| | | | various sizes, stable over time |
| | | | FP: pink yellowish color, |
| | | | thick, smooth, creamy, fruity, a |
| | | | bit acidic |
| 10 | 2.12 | 7.5 | Prep: pink with whitish color, |
| | | | viscous matrix, visible fruit |
| | | | pieces of various sizes, stable |
| | | | over time |
| | | | FP: pink yellowish color, |
| | | | thick, creamy, sweet and |
| | | | acidic, less smooth and fruity |
| | | | compared to sample 9 |
| 11 | 1.54 | 6.5 | Prep: red color, smooth, more |
| | | | fluid, fruit pieces better |
| | | | preserved, fruit pieces settle to |
| | | | the bottom over time |
| | | | FP: pink color, fluid, smooth, |
| | | | slight astringency, acidic, not |
| | | | very fruity |

Fruit preparation viscosity increased in all samples at day 2 post production relative to day 0. Sample 8 had the highest viscosity among the samples having 1.6% to 4% whey protein, with a viscosity of 1.41 Pa·s at 2 days post production. Later experiments (samples 9-11) showed that a whey protein content of 5.4% or higher (higher whey protein content tested in experiments not shown) could increase viscosity over the maximum amount of 4% whey protein tested in the first experiments. Higher total whey protein concentration in a fruit preparation correlated with higher dynamic viscosity of the fruit preparation with pasteurization at 92° C. for 3 minutes.

Pasteurization of fruit preparations at 92° C. for 3 minutes also increased viscosity over fruit preparations pasteurized at 85° C. for 8 minutes. It was observed that gelation of a whey protein solution began at 92° C. and continued through pasteurization at 92° C., and completed during cooling. Without being bound to theory, it is believed that gelation of whey protein may be linked to protein denaturation. Whey protein denaturation is typically at about 60% when the temperature reaches 92° C., but denaturation increases during pasteurization at 92° C. to about 70% after 5 minutes, and typically more than 80% after 15 minutes.

It is noted that calcium need not be added to achieve the desired results, but can contribute to an increase in fruit prep viscosity. Without being bound to theory, it is believed that calcium in some ingredients, such as water, the whey protein source, or fruit can contribute to gelling of the whey protein. However, in some cases, calcium can be added to achieve a calcium concentration of 20 mM to 50 mM to further improve gelling.

The results of this experiment show that, by combining a fruit ingredient (at least 30% by weight) and whey protein (at least 4% by weight), then thermally treating the mixture at a temperature of 85-92° C. for a time of 3-8 minutes, preferably 92° C. for 3 minutes, a pasteurized fruit preparation can be made with a viscosity and consistency suitable for substitution for traditional fruit preparations.

### Example 2—Fruit Preparation with Denatured Whey Protein (Also Referred to Herein as “Cold Gelation”)

Whey protein solutions having a whey protein concentration of 8-15% by weight were made by combining a whey protein concentrate powder (80% protein) with water, then combined with sucrose and calcium (as a calcium salt), as shown in Table 3. The whey protein solutions were then heat treated as shown in Table 3, to induce gelation. Table 3 describes stage of the gel (e.g., liquid or gelled) prior to adding the gel to fruit to make a fruit prep.

Each sample fruit preparation included 65% by weight fruit, a total of 15% sucrose (in some cases, part of the sucrose was added to whey protein solution prior to denaturation, otherwise, sucrose was added to the fruit preparation). pH of the whey protein solution was eventually adjusted to less than 4.5 using citric acid prior to denaturation (except sample 9). Whey protein concentration was preferred to be at or below 15% to prevent spontaneous gelation in the solution. Calcium salts were added either to the whey protein solution prior to functionalization, added to the final fruit preparation, or a portion of calcium salts was added at both steps. Whey protein solution, after heat treatment (referred to as “gel” in Table 3, even if gelation hadn't occurred yet), was added to fruit pieces that were at a temperature of 92° C. just before pasteurization at 92° C. for 3 minutes. The total whey protein concentration in the fruit preparations ranged from 0.8% to 2.7% by weight. A control fruit preparation was made using the same ingredients and process, but without whey protein, and was used for comparison.

TABLE 3

| | | | | | Calcium | | |
|---|---|---|---|---|---|---|---|
| | Heat | | | Calcium | (mmoles) | | |
| | treatment | Whey | | (mmoles) | added | | Gel (% |
| | of whey | protein | Sucrose | provided | directly | Stage of | by |
| | protein | (% by | (% by | by gel in | in fruit | gel when | weight) |
| | solution | weight) | weight) | 100 g | per 100 g | added to | in fruit |
| Sample | (temp/time) | in gel | in gel | fruit prep | fruit prep | fruit | prep |
| (0) | 80° C./5-10 | 12 | 12 | 0.6 | 0.6 | Kept at | 14 |
| | minutes | | | | | 80° C. | |
| 1 | 75° C./35 | 8 | 0 | 0.8 | 0.8 | Gelled, not | 18 |
| | minutes | | | | | allowed to cool, | |
| | | | | | | added at 75° C. | |
| 2 | 90° C./3-5 | 8 | 0 | 0 | 0 | Cold, 1 day | 18 |
| | minutes | | | | | post production | |
| 3 | 75° C./35 | 15 | 0 | 0 | 1.5 | Cold, 1 day | 10 |
| | minutes | | | | | post production | |
| 4 | 90° C./3-5 | 15 | 0 | 1.5 | 0 | Gelled, not | 10 |
| | minutes | | | | | allowed to cool, | |
| | | | | | | added at 90° C. | |
| 5 | 75° C./35 | 8 | 24 | 0.8 | 0 | Cold, 1 day | 10 |
| | minutes | | | | | post production | |
| 6 | 90° C./3-5 | 8 | 24 | 0 | 0.8 | Gelled, not | 10 |
| | minutes | | | | | allowed to cool, | |
| | | | | | | added at 90° C. | |
| 7 | 75° C./35 | 15 | 24 | 0 | 0 | Gelled, not | 18 |
| | minutes | | | | | allowed to cool, | |
| | | | | | | added at 75° C. | |
| 8 | 90° C./3-5 | 15 | 24 | 1.5 | 1.5 | Cold, 1 day | 18 |
| | minutes | | | | | post production | |
| 9 | 65° C./30 | 30 | 0 | 0 | 0 | Gelled, not | 18 |
| | minutes at | | | | | allowed to cool, | |
| | pH ≥ 6 | | | | | added at 90° C. | |

Dynamic viscosity was measured for each sample in Table 3 as described above, and are shown in Table 4. Observations of the gel samples prior to addition with fruit are provided in Table 4. Observations on viscosity, mouth feel, and flavor for each fruit preparation alone, or in a yogurt white mass, are also described in Table 4.

TABLE 4

| | Dynamic viscosity | | | |
|---|---|---|---|---|
| | of the fruit | Bostwick | | Observations of fruit |
| | preparation | Cenco | | prep (Prep) and |
| | (Pa*s at 10° C. | (cm/min at | | finished product (FP) |
| | and 60 s⁻¹¹) at 2 | 10° C.) at 1 | Observations of the | with 80% yogurt |
| | days post- | day post- | gel prior to addition | white mass and 20% |
| Sample | production | production | with fruit | fruit prep |
| (0) | 0.92 | | Yellowish, opaque, | Prep: Slight syneresis, |
| | | | spoonable, smooth | and sedimentation; |
| | | | | Much higher viscosity |
| | | | | compared to control |
| | | | | FP: Thickest of the |
| | | | | tested samples; good |
| | | | | texture, smooth, fruity |
| 1 | 0.68 | | White, slightly | Prep: Syneresis and |
| | | | opaque, liquid, | sedimentation |
| | | | smooth | FP: Very thick and |
| | | | | smooth, creamy; |
| | | | | fruity with slight |
| | | | | protein taste |
| 2 | 0.75 | | Yellowish, | Prep: Syneresis and |
| | | | transparent, | sedimentation |
| | | | spoonable, brittle | FP: Not very thick, |
| | | | and friable gel, | visible microgels, |
| | | | becomes flexible | watery in the mouth, |
| | | | with stirring, | slight protein taste |
| | | | smooth | |
| 3 | 0.71 | | Yellowish, opaque, | Prep: Syneresis and |
| | | | spoonable, | sedimentation |
| | | | rough/grainy, | FP: Very thick, |
| | | | friable but flexible | grainy, flavor not |
| | | | gel | acceptable |
| 4 | 0.69 | | White, opaque, | Prep: Syneresis and |
| | | | spoonable, very | sedimentation |
| | | | sandy, large elastic | FP: Very thick, good |
| | | | aggregates, brittle | body in mouth, |
| | | | and friable gel | creamy, smooth, fruity |
| 5 | 0.72 | | White, opaque, very | Prep: Syneresis, fruit |
| | | | liquid, smooth | floats to the top |
| | | | | FP: Very thick, but |
| | | | | watery in the mouth, |
| | | | | some granulation, |
| | | | | protein taste |
| 6 | 0.9 | | Yellowish, slightly | Prep: Slight syneresis, |
| | | | opaque, spoonable, | sedimentation; much |
| | | | brittle gel, becomes | more viscous than |
| | | | flexible with | control |
| | | | stirring, smooth | FP: Very thick, visible |
| | | | | granulation, very |
| | | | | fruity flavor, slight |
| | | | | protein taste |
| 7 | 0.8 | | Slightly yellow, | Prep: No syneresis, |
| | | | opaque, liquid, | some sedimentation, |
| | | | smooth, low | gel in fruit prep is light |
| | | | homogeneity | in color with some |
| | | | | white specks |
| | | | | FP: Thin, powdery |
| | | | | texture in mouth, most |
| | | | | sour and astringent of |
| | | | | all the tested samples, |
| | | | | calcium taste |
| 8 | 1.07 | | White, opaque, | Prep: Slight syneresis, |
| | | | spoonable, flexible, | gel in fruit prep is light |
| | | | sticky (like a dessert | in color with some |
| | | | cream), smooth | white specks, much |
| | | | | more viscous than |
| | | | | control |
| | | | | FP: Very thick, |
| | | | | somewhat watery |
| | | | | texture in the mouth, |
| | | | | astringent, |
| | | | | granulation, protein |
| | | | | taste |
| 9 | 1.5 | 6 | | Prep: Violet color, |
| | | | | quite thick but sandy |
| | | | | (visible protein |
| | | | | grains), fruit pieces |
| | | | | acceptable, slight |
| | | | | syneresis over time |
| | | | | FP: pink color, quite |
| | | | | thick, smooth, fruity, |
| | | | | sweet, not acidic, |
| | | | | slight astringency |

As in Example 1, fruit preparation viscosity increased in all samples at day 2 post production relative to day 0. Sample 8 had the highest viscosity among the fruit preps having 0.8% to 2.700 whey protein, with a viscosity of 1.07 Pa·s at 2 days post production. Later experiment (sample 9) showed that a whey protein content of 5.400 or higher (higher whey protein content tested in experiments not shown) could increase viscosity over samples with 2.7% whey protein in the earlier experiments. Higher total whey protein concentration in the fruit preparation correlated with higher dynamic viscosity of the fruit preparation.

It was observed that calcium need not be added to achieve the desired results. However, calcium added directly to fruit can provide a slight improvement in the texture of the finished product (fruit preparation plus yogurt white mass). Without being bound to theory, it is believed that calcium added to the fruit results in interaction of the calcium with whey protein after its denaturation, leading to gelation by reduction or neutralization of repulsion forces (calcium-induced cold gelation). These gels are typically stronger and more brittle than gels with no added calcium by reinforcing acid-induced cold gelation. Calcium included in whey protein solution provides little or no role in fruit prep viscosity or finished product texture.

It was also observed that sugar added to the whey protein solution prior to gelation provided the greatest positive impact on the viscosity of the fruit preparation relative to when the sugar was added to the preparation after gelation (e.g., added with the fruit).

The stage of the gel when added to the fruit has little to no role in fruit prep viscosity or finished product texture.

Heat treatment can affect fruit prep viscosity and finished product texture, with higher temperatures (e.g., 92° C.) being more effective.

The results of this experiment show that, by combining a whey protein gel with a fruit ingredient (at least 30% by weight) to achieve a mixture having at least 3% whey protein by weight, then pasteurizing the mixture (preferably at 92° C.), a pasteurized fruit preparation can be made with a viscosity and consistency suitable for substitution for traditional fruit preparations.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A fruit preparation, the fruit preparation having a pH of from 3 to 4.5, a dynamic viscosity of 0.5 to 4 Pa*s as measured at 10° C. and 60 s-1, and a consistency of from about 5 cm/min to about 8 cm/min as measured at 10° C., wherein the fruit preparation consists of about 3% to about 10% by weight whey protein, at least 30% by weight of a fruit ingredient that includes fruit pieces, up to 20% water, up to 59% by weight sugar, and up to 10% additives.

2. (canceled)

3. The fruit preparation of claim 1, wherein the fruit preparation includes up to 5% by weight organic acid.

4. The fruit preparation of claim 1, wherein the fruit preparation includes whey protein in an amount of about 5% to about 7% by weight.

5. A food product comprising the fruit preparation of claim 1, and a second edible composition.

6. The food product of claim 5, wherein the second edible composition is a dairy product.

7. A method of making a fruit preparation, comprising:
a. combining a whey protein solution with a fruit ingredient to produce a mixture having about 4% to about 10% by weight whey protein, at least 30% fruit ingredient, up to 20% water, up to 59% by weight sugar, and up to 10% additives;
b. pasteurizing the mixture at a temperature of from 85° C. to 100° C. for 2 minutes to 15 minutes; and
c. cooling the mixture to a temperature of 40° C. or less to produce the fruit preparation, the fruit preparation having a pH of from 3 to 4.5, a dynamic viscosity of 0.5 to 4.0 Pa*s as measured at 10° C. and 60 s-1, and a consistency of from about 5 cm/min and about 8 cm/min as measured at 10° C.

8. A method of making a fruit preparation, comprising:
a. combining a whey protein powder with a fruit juice or fruit puree to produce a mixture having about 4% to about 10% by weight whey protein, at least 30% by weight fruit, up to 20% water, up to 59% by weight sugar, and up to 10% additives;
b. pasteurizing the mixture at a temperature of from 85° C. to 100° C. for 2 minutes to 15 minutes; and
c. cooling the mixture to a temperature of 40° C. or less to produce the fruit preparation, the fruit preparation having a pH of from 3 to 4.5, a dynamic viscosity of 0.5 to 4.0 Pa*s as measured at 10° C. and 60 s-1, and a consistency of from about 5 cm/min and about 8 cm/min as measured at 10° C.

9. (canceled)

10. A method of making a fruit preparation, comprising:
a. thermally treating a whey protein solution to achieve at least 60% denaturation to form a whey base, the whey protein solution having a protein concentration of about 6% to about 40% by weight;
b. pasteurizing the whey base; and
c. combining the whey base with a fruit ingredient to produce the fruit preparation, the fruit preparation having about 3% to about 10% by weight whey protein, at least 30% by weight fruit, up to 20% water, up to 59% by weight sugar, and up to 10% additives, and having a pH of from 3 to 4.5 and a dynamic viscosity of 0.5 to 4 Pa*s as measured at 10° C. and 60 s-1, and a consistency of from about 5 cm/min to about 8 cm/min as measured at 10° C.

11. The method of claim 10, wherein the thermal treatment of the whey protein solution is at a temperature of from 60° C. to 80° C. for 5 to 50 minutes at a pH greater than 4.5.

12. The method of claim 10, wherein the thermal treatment step and the pasteurization step are performed at substantially the same time.

13. (canceled)

14. The method of claim 10, wherein the whey protein solution is thermally treated at a pH of greater than 6.

15. The method of claim 10, wherein the fruit ingredient has a pH of less than 4.

16-17. (canceled)

18. The method of claim 7, wherein the whey protein solution has a whey protein concentration of about 12% to about 30%.

19. The method of claim 7, wherein the fruit preparation includes whey in an amount of about 5% to about 7% by weight.

20. The method of claim 7, wherein the whey protein solution contains up to 50% sugar by weight.

21-22. (canceled)

23. The method of claim 8, further comprising a step of adding Ca2+ to the mixture to achieve a fruit preparation having a Ca2+ concentration of from about 20 mM to about 50 mM.

24. The method of claim 10, wherein the whey protein solution has a whey protein concentration of about 12% to about 30%.

25. The method of claim 8, wherein the fruit preparation includes whey in an amount of about 5% to about 7% by weight.

26. The method of claim 10, wherein the fruit preparation includes whey in an amount of about 5% to about 7% by weight.

27. The method of claim 10, wherein the whey protein solution contains up to 50% sugar by weight.

28. The method of claim 8, further comprising a step of adding Ca2+ to the mixture to achieve a fruit preparation having a Ca2+ concentration of from about 20 mM to about 50 mM.
